(19) United States
(12) Patent Application Publication
(10) Pub. No.: US 2023/0194899 A1
(43) Pub. Date: Jun. 22, 2023

(54) AUGMENTED REALITY SMART GLASS

(71) Applicant: SHENZHEN AUGMENTED REALITY TECHNOLOGLES CO. LTD., SHENZHEN CITY, GUANGDONG (CN)

(72) Inventors: BO SU, SHENZHEN CITY, GUANGDONG (CN); YOUCHU WANG, SHENZHEN CITY, GUANGDONG (CN)

(21) Appl. No.: 16/346,912

(22) PCT Filed: Mar. 8, 2017
(86) PCT No.: PCT/CN2017/076004

§ 371 Date: May 2, 2019

(30) Foreign Application Priority Data
May 12, 2016 (CN) 201610316393.6
May 12, 2016 (CN) 201610316394.0
May 12, 2016 (CN) 201610316464.2
May 12, 2016 (CN) 201620434045.4
May 12, 2016 (CN) 201620437986.3
May 12, 2016 (CN) 201620440890.2

(51) Int. Cl. G02C 11/00; G02C 5/12; G02C 5/14; G02B 27/01

(52) U.S. Cl. CPC G02C 11/10; G02C 5/126; G02C 5/14; G02B 27/0172; G02B 2027/0132; G02B 2027/0138; G02B 2027/0178

(57) ABSTRACT

An integrated binocular augmented reality smart glass, which comprises an integrated structure of glass temples, an imaging system, a nose pad, a battery module and a glass frame, and a circuit board processor module and a control system are integrated therein. The integrated binocular augmented reality smart glass has a small volume, a light weight and a strong mobile flexibility and is convenient in usage and interaction, and can be worn stably for a long time under various application scenarios without generating discomfort. The imaging system of the integrated binocular augmented reality smart glass is a multi-layer structure, and comprises filter glasses, display glasses and functional glasses, where the filter glasses and the functional glasses are respectively located at two sides of the display glasses and are mounted on the glass frame.

### BACKGROUND OF THE INVENTION

### 1. Field of the Invention

The present invention relates to a binocular augmented reality smart glass, and specifically, to an integrated binocular augmented reality smart glass, a multi-layer structure for the integrated binocular augmented reality smart glass, and a user-friendly fixation system for the augmented reality smart glass.

### 2. Description of Related Art

An augmented reality technology is a new technology of “seamlessly” interweaving information of the real world and information of the virtual world. Physical information (visual information, auditory information, olfactory information, haptic information and the like) that is originally improbable within particular ranges of time and space in the real world is simulated and then superimposed by using computer technologies and the like. Virtual information is applied to the real world and perceived by sensory organs of human beings to create sensory experience that is beyond the reality. An augmented reality smart glass is a leading-edge application of the augmented reality technology. A smart glass is used as a carrier to combine information of various virtual technologies and real-world operations, can play a significant role in the fields such as training, medical care, military, and industrial production, and therefore is gaining increasing attention.

Generally, compared with a conventional glass, an augmented reality smart glass has a more complex structure and a heavier weight. The augmented reality smart glass generally includes an integrated structure of glass temples, an imaging system, a nose pad, a battery module and a glass frame, and therefore has a relatively heavy overall weight. Especially, during application, the augmented reality smart glass needs to be worn for a relatively long time, for example, usually several hours or even more than ten hours.

For example, currently, a common augmented reality smart glass may include a monocular augmented reality smart glass and a binocular augmented reality smart glass. For the monocular augmented reality smart glass, Google launched an integrated monocular augmented reality smart glass named Google Glass in 2012. Google Glass only uses an augmented reality imaging system with a monocular lens for imaging. Therefore, the structure is relatively simple and the weight is relatively light. However, because Google Glass only implements monocular imaging, the field-of-view angle of the imaging is relatively small and the imaging is easily susceptible to shakes. After a long time of monocular focusing, the vision of a wearer may be affected, and a user may even feel dizzy or other physical discomfort in severe cases. A binocular augmented reality smart glass uses binocular imaging and can implement a relatively large field-of-view angle and is insusceptible to shakes, and provides a wearer with more comfort and better use experience than a monocular augmented reality smart glass. However, more components are required to implement binocular imaging. As a result, a binocular augmented reality smart glass usually has a large volume and a relatively heavy weight (generally more than 500 grams). It is therefore difficult to wear such a glass stably for a long time. This is an important constraint on further development in actual applications.

In addition, for example, a headband binocular augmented reality glass named Microsoft HoloLens still has a large and heavy main unit. Microsoft HoloLens is still not suitable for long-time use and still needs to be improved in the adaptability to application scenarios, practicability, comfort, and experience.

Existing augmented reality smart glass systems have disadvantages such as a complex system, low adaptability, and an undesirable imaging effect. For example, the imaging effects of most existing augmented reality smart glass systems are easily susceptible to ambient light when there is intense ambient lighting, resulting in reduced imaging quality. For another example, generally, existing augmented reality smart glass systems are relatively heavy and have low structural adaptability. A patient with myopia, hyperopia or other vision problems needs to wear glasses. During the use of most existing augmented reality smart glasses, a wearer may need to wear corneal contact lenses, or the entire hardware system and software system of the glass system need to be separately modified for a specific user, leading to a complex process and high costs. In addition, in some special fields, augmented reality smart glass systems may further need to have special functions such as night vision and spectrum filtering. Existing augmented reality smart glass systems usually cannot satisfy such requirements. In addition, display glasses of augmented reality smart glasses are expensive and require precision, and may be easily damaged after long-time exposure to a harsh working environment (a greasy environment, a dusty environment or the like), and it is expensive to change and repair the display glasses.

Moreover, at present, none of the augmented reality smart glasses in this field provides a fixation system that allows a user to wear and use the smart glasses comfortably and safely for a long time.

Therefore, there is an urgent need in this field for a novel augmented reality smart glass that can overcome the disadvantages of the foregoing existing augmented reality smart glasses. The augmented reality smart glass should implement a desirable display effect and wear experience, have a small volume and a light weight, and implement actual modular integration without using an additional peripheral, and can be worn like normal glasses to actually free the hands of a user, so that the augmented reality smart glass can adapt to changing use environmental requirements and can be conveniently carried and transported. Moreover, the augmented reality smart glass has clearer imaging, higher adaptability, and lower costs, and can adapt to harsh use environments. In addition, the augmented reality smart glass can provide a user with a user-friendly fixation system to provide user-friendly fixation, so that the user feels comfortable and secure after wearing, it is suitable and easy to wear the augmented reality smart glass for a long time, and it is easy to disassemble, dismount, maintain, and change the augmented reality smart glass.

### SUMMARY OF THE INVENTION

Various aspects and advantages of the present invention will be set forth in part hereinafter or will become apparent from the following description or may be learned by practicing the present invention.

According to an exemplary aspect of the present invention, an integrated binocular augmented reality smart glass is provided, including an integrated structure of glass temples, an imaging system, a nose pad, a battery module and a glass frame, where a circuit board processor module and a control system are integrated therein. According to an exemplary aspect, the glass temples form an approximately annular open structure surrounding a head outline. According to an exemplary aspect, the imaging system includes filter glasses, display glasses and functional glasses. According to an exemplary aspect, the battery module is mounted on the glass temple. According to another exemplary aspect, the augmented reality smart glass according to the present invention may further be connected to an external power supply. According to an exemplary aspect, a heat sink structure is further disposed on the glass frame. According to an exemplary aspect, a control button and a user-defined multifunctional button are disposed on the glass temple. According to an exemplary aspect, tail-end parts of the glass temples are detachable. According to an exemplary aspect, the battery module is positioned to counteract the weight of the glass frame. According to another exemplary aspect, the nose pad and the filter glasses and the functional glasses of the imaging system are also detachable. According to still another aspect, the nose pad is an L-shaped raised nose pad.

According to an exemplary aspect of the present invention, a multi-layer augmented reality smart glass is provided, including an integrated structure of glass temples, an imaging system, a nose pad, a battery module and a glass frame, where a circuit board processor module and a control system are integrated therein. According to an exemplary aspect, the imaging system is a three-layer structure and includes filter glasses, augmented reality smart display glasses and functional glasses. However, a person skilled in the art may also choose as required a structure with more or fewer layers. In an exemplary embodiment of the multi-layer augmented reality smart glass according to the present invention, the filter glasses and the functional glasses are respectively located at two sides of the augmented reality smart display glasses and are mounted on the glass frame via detachable structures, so that while the display glasses can be used to achieve better imaging, the display glasses in the middle also provides protection.

For the foregoing imaging system with the three-layer structure, before reaching the eyes of a wearer, ambient light sequentially passes through the filter glasses, the display glasses and the functional glasses of the augmented reality smart glass according to the present invention. Filtering characteristics of the filter glasses may be selected as required to filter out a light ray that adversely affects an imaging effect of the display glasses of the smart glass in the ambient light. In addition, the filter glasses further serve as a background wall for image projection. The reason is that a screen presented right in front of human eyes by the display glasses of the smart glass is a translucent virtual screen. Excessively strong ambient light makes it difficult for human eyes to clearly distinguish content displayed on the translucent virtual screen. The filtering of the filter glasses creates a relatively dark background region for the translucent virtual screen, so that the imaging effect of the display glasses of the smart glass can be improved. In addition, the ambient light also passes through the functional glasses after passing through the filter glasses and the display glasses of the smart glass. In one exemplary embodiment, the functional glasses are vision correction glasses. A wearer with an eye disease such as myopia, hyperopia and astigmatism may directly choose glasses having a suitable correction effect, and the glasses are mounted easily on the glass frame via detachable structures, so as to adapt to different wearers without substantially modifying the smart glass. Moreover, based on different requirements, different functional glasses may further be selected.

In addition, the filter glasses and the functional glasses are respectively disposed at two sides of the augmented reality smart display glasses, so that the display glasses are effectively isolated from the immediate environment. This is especially important in a harsh use environment such as a greasy or dusty environment. Surrounded by the filter glasses and the functional glasses, the display glasses are less susceptible to grease or dust in the immediate environment because most of the grease or dust is deposited on the filter glasses and the functional glasses. The filter glasses and the functional glasses may be attached to the glass frame via detachable structures, and therefore can be easily removed from the glass frame to be cleaned or directly changed, so that operations are simple and convenient and costs are very low.

According to the present invention, a user-friendly fixation system for a smart glass, in particular, an augmented reality smart glass is provided. The user-friendly fixation system includes: a detachable nose pad assembly, where the nose pad assembly at least includes a pair of nose pads, and the nose pads increase a contact area between the smart glass and the nasal bridge of a user when the user wears the smart glass; and a pair of foldable glass temples, where each glass temple at least includes a front glass-temple section and a rear glass-temple section, and the foldable glass temples are formed to basically match the head shape of the user when the user wears the smart glass.

According to an exemplary aspect of the present invention, the pair of nose pads of the detachable nose pad assembly are arranged to form an included angle of approximately 20 degrees to 40 degrees, more preferably, approximately 25 degrees to 35 degrees, and most preferably, 33 degrees to 35 degrees (for example, approximately 34.4 degrees), and extend upwards to intersect with each other to form an upper joint or to be connected to an additional upper joint.

According to an exemplary aspect of the present invention, the upper joint has a magnetic attraction structure, and/or the upper joint has a foolproof design.

According to an exemplary aspect of the present invention, the nose pad is a bent-shaped or an approximately L-shaped raised nose pad, where each nose pad is formed of a nose pad support and a nasal bridge contact portion that are preferably integrally molded and form an approximately bent shape or an approximately L shape, and the nasal bridge contact portion has a flaring part.

According to an exemplary aspect of the present invention, the nasal bridge contact portion has a covering or coating made of a soft material.

According to an exemplary aspect of the present invention, the foldable glass temple has an increasing width, and preferably the front glass-temple section has a structure with an increasing width.

According to an exemplary aspect of the present invention, the rear glass-temple section is extended to form a curvature that basically matches the back of the head of the user.

According to an exemplary aspect of the present invention, the pair of foldable glass temples form a completely closed headband structure or an approximately annular open structure.

According to an exemplary aspect of the present invention, the foldable glass temples are constructed to enable a member that is mounted on the foldable glass temples and can additionally serve as a counterweight to be positioned near ear fulcrums or located at a position behind the ear fulcrums in a worn state.

According to an exemplary aspect of the present invention, a hole is opened in the foldable glass temple, preferably at an approximately middle position of the rear glass-temple section, and is used for a thin belt to pass through and be fixed.

According to another exemplary aspect, the nose pads and an imaging system are also detachable.

According to another exemplary aspect of the present invention, use of a binocular augmented reality smart glass according to the present invention is provided. The binocular augmented reality smart glass is widely applied to aviation repair, automobile repair, practical operation training, manufacturing and assembly, electrical energy source inspection and maintenance, medical care surgery, warehousing and logistics, laboratory education and training, military machinery inspection and repair, military commanding, individual combat, on-site engineering services, remote assistance of various on-site services, and the like.

With reference to the following description and the appended claims, these and other features, aspects and advantages of the present invention will become more comprehensible. The embodiments of the present invention are shown in combination with the accompanying drawings that are in the specification and constitute a part of the specification, and the embodiments and the description are used together to illustrate the principle of the present invention.

### BRIEF DESCRIPTION OF THE DRAWINGS

The complete and implementable disclosure of the present invention for a person of ordinary skill in the art is described in the specification, and includes an optimal mode, where the accompanying drawings are cited, and the accompanying drawings are as follows:

FIG. 1 is a perspective view of a binocular augmented reality smart glass according to an exemplary embodiment of the present invention;

FIG. 2 is a top view of the binocular augmented reality smart glass in FIG. 1;

FIG. 3 is a right view of the binocular augmented reality smart glass in FIG. 1;

FIG. 4 is a detailed view of a multi-layer imaging system of the augmented reality smart glass shown in FIG. 1;

FIG. 5 is an exploded view of the multi-layer imaging system shown in FIG. 4;

FIG. 6 is a three-dimensional view of a nose pad assembly according to a preferred embodiment of the present invention seen from an approximately front angle, and schematically shows the basic structure of the nose pad assembly; and

FIG. 7 is a three-dimensional view of the nose pad assembly shown in FIG. 6 from an approximately side rear angle, and schematically shows the basic structure of the nose pad assembly from the approximately side rear angle.

### DETAILED DESCRIPTION OF THE PREFERRED EMBODIMENTS

Several preferred embodiments of the present invention are described in detail now with reference to the accompanying drawings. However, a person skilled in the art should understand that these implementations only enumerate some specific embodiments of the present invention, but does not constitute any limitation to the present invention and the protection scope thereof. The embodiments in this specification only intend to illustrate the principle of the present invention rather than to limit the scope of the present invention. The patent scope of the present invention may be limited by only the claims.

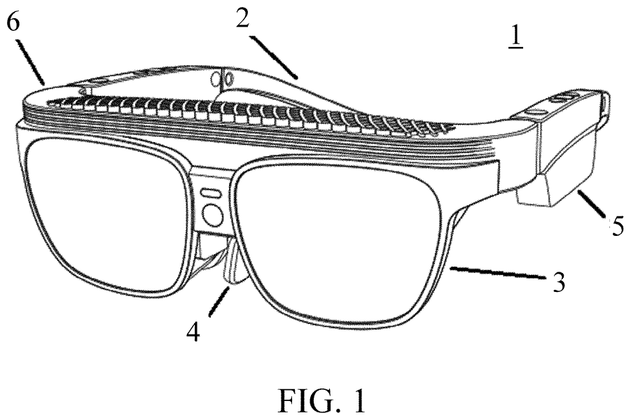

FIG. 1 shows a binocular augmented reality smart glass 1 according to an exemplary embodiment of the present invention. The binocular augmented reality smart glass 1 includes a pair of glass temples 2, a set of imaging systems 3, a pair of nose pads 4, a battery module 5 and a glass frame 6, and a circuit board processor module and a control system (not shown) are integrated therein. According to an exemplary embodiment, the circuit board processor module is located at the top of the front section of the glass frame 6. The control system is located above the front middle of the glass temple 2. A person skilled in the art may conceive of integrating the circuit board processor module and the control system as required at different positions. The imaging system 3 is a multi-layer structure. According to an exemplary embodiment, the imaging system 3 includes filter glasses, display glasses and functional glasses. As can be seen from FIG. 1, in the augmented reality smart glass 1 of the present invention, all functional modules of a binocular augmented reality smart glass are integrated in a structure similar to that of normal glasses. The augmented reality smart glass 1 has a compact structure, a small volume (according to a non-limitative embodiment of the present invention, if the glass temples 2 are opened, the size of the binocular augmented reality smart glass according to the present invention is 206.8 mm*154.4 mm*54.2 mm) and a light weight (according to a non-limitative embodiment of the present invention, if a set of battery modules 5 are included, the overall weight of the binocular augmented reality smart glass according to the present invention may be reduced to about 160 grams), so that it becomes possible to wear the smart glass 1 for a long time. Moreover, because the circuit board processor module and the control system are completely integrated in the main unit of the smart glass according to the present invention, an external heavy handheld module is no longer needed, and it is no longer necessary to operate the handheld module separately to manipulate the smart glass, so that the hands of a user are actually freed, and the user can operate the smart glass more flexibly, thereby improving the working efficiency.

As shown in the figure, the glass temples 2 are an approximately annular open structure rather than a completely closed headband structure. The battery module 5 is combined on the glass temple 2, so that it becomes convenient to wear the smart glass 1, the discomfort that a wearer usually feels when wearing a conventional binocular augmented reality smart glass is eliminated, and the wearer can wear and use the smart glass for a long time without an external power supply. Depending on the capacity of a single battery module 5, the influence on the overall weight, and an actual application requirement, only one battery module 5 may be disposed on one glass temple 2, or two battery modules 5 may be symmetrically disposed on the glass temples 2 respectively. Certainly, if necessary, the glass 1 may be alternatively connected to a large capacity external power supply through a power connection line (not shown in FIG. 1). In addition, the battery module 5 may further be charged by using a USB interface that supports charging and data transmission and is disposed at a front-end part of the glass temple 2.

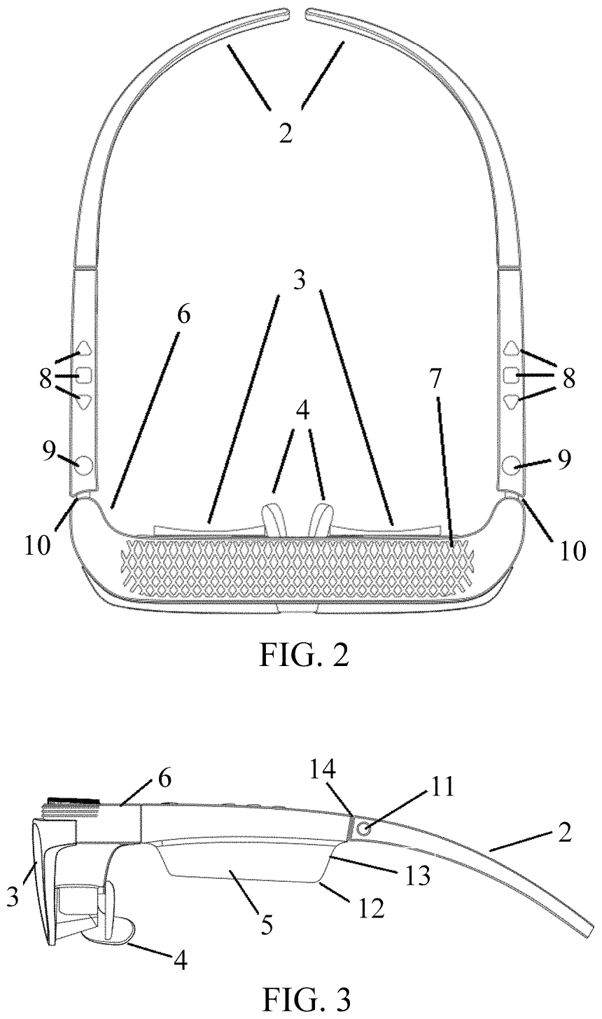

FIG. 2 is a top view of the binocular augmented reality smart glass shown in FIG. 1. As shown in the figure, the binocular augmented reality smart glass according to the present invention has a centrosymmetric structure. A control button 8 is disposed separately on both the glass temples 2, so as to jointly control or separately control the content displayed by the imaging system 3. The position of the control button 8 shown in the figure is only exemplary, and may be alternatively disposed on the side surface of the glass temple 2 or the glass frame 6, and control buttons 8 are not necessarily disposed in pair, depending on an actual application requirement. A heat sink structure 7 is further disposed on the glass frame 6, and is usually a hollowed-out structure or any other structure that facilitates dissipation of heat inside the glass frame 6. To further reduce the overall weight of the augmented reality smart glass according to the present invention, the glass temples 2 and the glass frame 6 are usually made of a composite material with low density but high strength. For example, the glass frame 6 may be made of a PC+ABS material. The glass temples 2 may be made of a TPU+steel material. A multifunctional button 9 is further disposed on the glass temple 2. The button is a user-defined button. A button function of the button can be defined on a user setting interface according to a use requirement of a wearer, thereby greatly expanding the application scope of the augmented reality smart glass according to the present invention. The glass temples 2 are connected to the glass frame 6 via a foldable hinge 10, so that the glass temples 2 can be folded.

FIG. 3 is right view of the binocular augmented reality smart glass according to the present invention. As shown in the figure, the battery module 5 is placed at a middle position of the glass temples 2. The battery module 5 is disposed at this position for the benefit that the weight of the battery module 5 may be used to counteract the weight of the glass frame 6 in the front of the glass, to avoid that the front end of the glass is excessively heavy and exert excessive pressure on the nose of a wearer. A through hole 11 is further opened in the glass temple 2, making it convenient to arrange a hanging rope or an additional external apparatus through the through hole 11. According to an actual requirement, without affecting the strength of a glass temple, different through holes or hollowed-out structures may further be provided at different positions to further reduce the weight or facilitate connection to another external apparatus. In addition, as can be seen from FIG. 3, for the glass temple 2, a detachable sectional structure is formed at the reference numeral 14. In a harsh working environment or after a long time of use, a tail-end part of the glass temple 2 closer to the right side in FIG. 3 is more likely than a front-end part close to the glass frame 6 to suffer from damage. By arranging such a sectional structure, a possibly damaged tail-end part can be changed more easily. Moreover, the nose pad 4 and the filter glasses and the functional glasses of the imaging system 3 shown in FIG. 3 are all designed to have detachable structures. In this way, during storage of the glass, the tail-end parts of the glass temples 2, the battery module 5, the nose pad 4 and the filter glasses and the functional glasses of the imaging system 3 may all be disassembled and separately stored and maintained, so that the volume and weight of the glass are further reduced during stored, and it is convenient to carry and transport the glass. A built-in loudspeaker and an earphone jack are further respectively disposed at positions of the reference numerals 12 and 13 on the front-end part of the glass temple 2. The two positions are close to ears of the wearer, so that the wearer can clearly hear sound from the built-in loudspeaker even in a noisy environment. If earphones are used, it is not necessary to arrange an excessively long earphone connection line, thereby avoiding discomfort during wear due to winding or dangling of an earphone line. In addition, the nose pad 4 is an L-shaped raised nose pad, and the structure can bear weight more effectively, thereby improving the comfort during wear. Moreover, a foolproof design is further provided on the nose pad 4, so as to avoid incorrect mounting and displacement and shaking after mounting.

To further reduce energy consumption and reduce the volume and weight of a circuit part the augmented reality smart glass according to the present invention, the inventor also makes an improvement to the circuit design. An HDI board design is used for a circuit board, so that the volume of a PCB board is minimized.

In the imaging system 3 of the binocular augmented reality smart glass 1 according to an exemplary embodiment of the present invention, a multi-layer structure is creatively used in the field of augmented reality smart glasses to produce various beneficial technical effects in the foregoing.

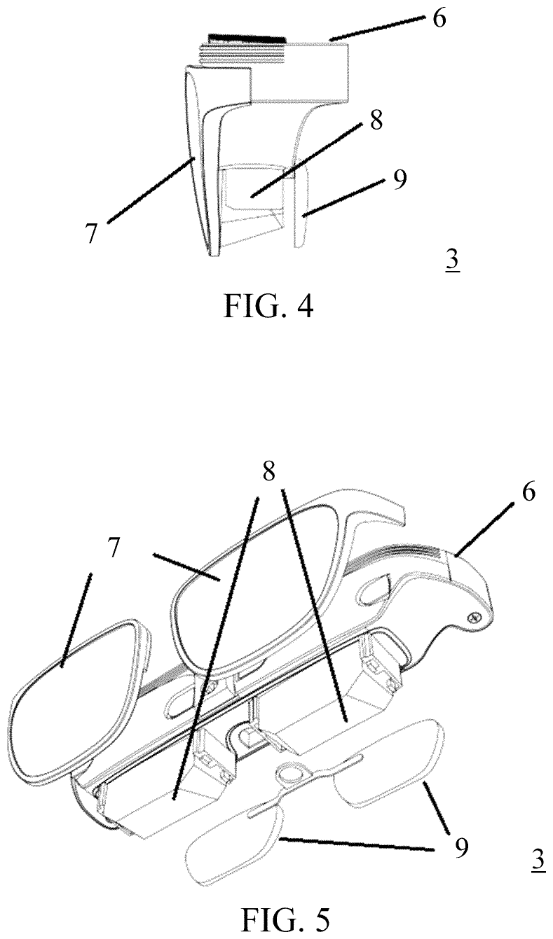

FIG. 4 is a side view that further shows a multi-layer imaging system 3 of the augmented reality smart glass according to the present invention 1. As shown in the figure, the multi-layer imaging system 3 sequentially includes filter glasses 7, display glasses 8 and functional glasses 9 from left to right. The filter glasses 7 and the functional glasses 9 are connected to the glass frame 6 via detachable structures, for example, magnetic attraction structures. Therefore, the filter glasses 7 and the functional glasses 9 protect the display glasses 8 in the middle, and may further change different filter glasses 7 and functional glasses 9 or maintain the filter glasses 7 and the functional glasses 9 as required. To prevent the imaging of the display glasses 8 from interfering with the vision of a wearer, the display glasses 8 also has high light transmittance. The light transmittance of the display glasses 8 may be between 45% and 85%, and is preferably between 50% and 65%, so that the wearer wearing the glass can clearly see through the multi-layer glass structure.

FIG. 5 is an exploded view that shows more clearly the structure of the multi-layer imaging system 3 shown in FIG. 2. It may be clearly seen that the filter glasses 7 and the functional glasses 9 are connected to the glass frame 6 via detachable structures and surround the display glasses 8 from two sides, so that an imaging effect on the display glasses 8 can further be improved, and the display glasses 8 is adequately protected.

A person skilled in the art should understand that the foregoing structure is only exemplary. Depending on specific requirements and use environments, the foregoing imaging system 3 may also include more glasses or even include only two layers of glasses or one layer of glasses. For example, for an augmented reality smart glass used in a relatively clean environment, display glasses do not need to be protected as carefully as in a harsh environment. In this case, if there is suitable ambient light or a wearer does not require vision correction or another function, filter glasses and functional glasses can be completely removed and only the display glasses are kept, so that while a satisfactory imaging effect can still be achieved, the weight of the entire system can further be reduced.

FIG. 1 shows a binocular augmented reality smart glass 1 according to an exemplary embodiment of the present invention, in which a user-friendly fixation system according to a preferred embodiment of the concept of the present invention is used. The binocular augmented reality smart glass 1 at least includes, but is not limited to, a pair of glass temples 2, a set of imaging systems 3, a pair of nose pads 4, a battery module 5 and a glass frame 6.

As shown in FIG. 1, in the augmented reality smart glass 1 of the present invention, some functional modules of a binocular augmented reality smart glass may be integrated in a structure similar to that of normal glasses. Compared with conventional glasses, such a binocular augmented reality smart glass is apparently much heavier. Therefore, an improved user-friendly fixation system over a conventional glass or an existing glass needs to be provided to allow comfortable wear for a long time.

The user-friendly fixation system according to the present invention at least includes, but is not limited to, an improved nose pad assembly and an improved glass temple 2.

The user-friendly fixation system in the present invention includes a pair of glass temples 2. As shown in FIG. 2 and FIG. 3, for the glass temple 2, a detachable sectional structure is preferably formed at, for example, the reference numeral 14. According to a preferred embodiment of the present invention, for each glass temple 2, a two-section foldable structure is used, and includes a front glass-temple section and a rear glass-temple section.

FIG. 3 is a right view of the binocular augmented reality smart glass shown in FIG. 1, and uses another view to show the user-friendly fixation system according to a preferred embodiment of the present invention. As shown in FIG. 3, the rear glass-temple section of the glass temple 2 is a glass temple section close to the right side in FIG. 3. The front glass-temple section is a glass temple section that is close to the glass frame 6 and is used to connect to the glass frame 6.

In a harsh working environment, after long-time use, the rear glass-temple section of the glass temple 2 close to the right side in FIG. 3 is more likely than the front glass-temple section close to the glass frame 6 to suffer from damage. By arranging such a sectional structure, a possibly damaged tail-end part can be changed more easily.

According to a preferred embodiment, the front glass-temple section and the rear glass-temple section may be detachably connected to each other via a pivotal structure, preferably, a hinge structure. Therefore, the rear glass-temple section is detachable or changeable, and can be conveniently changed when being damaged, instead of changing an entire glass temple part.

According to a preferred embodiment, the pair of glass temples 2 are formed, so that after the pair of glass temples 2 are assembled on the augmented reality smart glass 1, the shape of the pair of glass temples 2 basically matches the shape of the head of a human, and in particular, basically matches the shape of the back of the head of a human.

To achieve this, according to a preferred embodiment, the rear glass-temple section may be extended to form a particular curvature that basically matches the back of the head of a user, so as to surround the back of the head to facilitate stable wear. At least the rear glass-temple section is preferably made of a flexible material, in particular, an appropriately and elastically flexible material. By using this design, when the augmented reality smart glass 1 of the present invention is worn, a contact area between the smart glass 1 and a human head can be maximized, thereby reducing the pressure on the head and improving the comfort.

Based on this basic concept, in addition, preferably, a design of an increasing width is preferably used for the pair of glass temples 2, thereby further increasing the contact area between the glass 1 and the head of the user, reducing local pressure, and improving the comfort during wear. Preferably, the front glass-temple section may have an increasing width, thereby increasing the contact area between the glass 1 and the head skin and reducing the pressure.

Preferably, after being assembled on the glass 1, the two glass temples 2 may present an approximately annular open structure that basically fits the shape of the head (basically the back of the head) of the user, that is, an incompletely closed headband structure. By using this arrangement and structure, it becomes convenient to wear the smart glass 1, the discomfort that a wearer usually feels when wearing a conventional binocular augmented reality smart glass is eliminated, and the wearer can wear and use the smart glass for a long time without an external power supply.

Certainly, the inventor of the present invention further conceives of that after being assembled on the glass 1, the two glass temples 2 may preferably present a completely closed headband structure that basically fits the shape of the head (basically the back of the head) of the user, so as to provide a structure with a further improved fit and improved wear safety. For example, without constituting a limitation, connecting means that are connected to each other to form a closed-ring structure may be correspondingly disposed at the rear glass-temple sections of the two glass temples 2. Preferably, the connecting means may be connecting members that can be conveniently disassembled, for example, but is not limited to, a rubber band, an elastic band, and a hook-and-loop fastener (a Velcro nylon strap), so that the glass 1 of the present invention can further preferably be detachably fixed to the head of the user from the back of the head, so as to implement wear with improved comfort and safer fixation.

Preferably, a hole may be provided at an approximately middle position of the rear glass-temple section of the glass temple 2. A thin belt may pass through the hole. The thin belt may be hung on the neck when the glass 1 is worn, so as to prevent the glass from falling off, thereby increasing the safety of wear. For example, without constituting a limitation, as shown in FIG. 3, a through hole 11 is opened in the glass temple 2, making it convenient to arrange a hanging rope or an additional external apparatus through the through hole 11. According to an actual requirement, without affecting the strength of the glass temples, different through holes or hollowed-out structures may further be provided at different positions, for example, preferably, in the rear glass-temple section, to further reduce the weight or facilitate connection to another external apparatus.

According to a preferred embodiment of the present invention, the battery module 5 (or another member that can be used as a counterweight member) may be disposed at the middle end of the glass temple 2 and close to ear fulcrums during wear, so that the weight of the entire glass is more evenly distributed, and the pressure exerted by the weight of the front end of the glass on the nasal bridge through the nose pads is reduced, thereby reducing the pressure and in particular, increasing the comfort during long-time wear.

More preferably, according to another preferred embodiment of the present invention, if the battery module 5 needs to be assembled on the glass 1, the battery module 5 (or another member that can be used as a counterweight member) is combined at a position that is on the rear glass-temple section of each glass temple 2 and is located behind the ear of a user in a worn state, preferably, a position near a tail end of the rear glass-temple section. By using this arrangement and structure, in the user-friendly fixation system in the present invention, the glass temples 2 are used to configure the weight of an entire binocular augmented reality smart glass 1, so that after the user wears the binocular augmented reality smart glass 1, the ears of the user are actually used as fulcrums. According to the lever principle, the weight of the battery module 5 located at the rear side of the ear fulcrums are used to counteract (greatly reduce) the pressure exerted at the front side of the ear fulcrums by the binocular augmented reality smart glass 1 on the nasal bridge of the user via the nose pads 4, so that the weight of the glass 1 is balanced again, thereby greatly improving the comfort for the user during wear. The reason is that during the wear, the pressure exerted on the nasal bridge of the user is a major cause of the discomfort. This is well known and readily comprehensible to a person skilled in the art.

In addition, for the pair of glass temples 2, a symmetrical design and structure is preferably used, and basically the same weight and weight distribution is used, thereby maximizing the comfort.

The pair of glass temples 2 are preferably made of a light material to minimize the weight. The light material is, for example, but is not limited to, plastic, an aluminum alloy, an iron alloy or carbon fiber, and sufficient strength is kept at the same time.

The front glass-temple section and the rear glass-temple section of each glass temple 2 are preferably connected to each other via a pivotal structure or a hinge, and are preferably connected pivotally with respect to each other or connected partially and foldably.

Certainly, based on an improved embodiment of the present invention, the front glass-temple section and the rear glass-temple section of each glass temple 2 are preferably detachably connected.

According to an embodiment of the present invention, each glass temple 2 may be preferably connected to the glass frame 6 via a foldable hinge 10, so that the glass temples 2 are foldable. In another alternative embodiment, for example, without constituting a limitation, if the glass temples 2 are made of an appropriately flexible material, each glass temple 2 may be connected to the main body of the glass 1 in another manner. For example, each glass temple 2 may be alternatively connected in an unfoldable manner. In this case, for example, without constituting a limitation, the glass temple 2 may be alternatively connected to the main body of the glass via, for example, a magnetic attraction structure, so that it is convenient to disassemble, clean, maintain or change the glass temple 2.

A nose pad assembly used as a part of the user-friendly fixation system in the present invention is described below with reference to FIG. 1 to FIG. 5 and some specific embodiments, and is preferably a detachable nose pad assembly.

According to an embodiment of the present invention, as shown in FIG. 4 and FIG. 5, the detachable nose pad assembly includes, but is not limited to, a pair of nose pads 4. Preferably, the pair of nose pads 4 is formed into a structure similar to a “λ” shape (or a “\hat{ }” shape). The pair of nose pads 4 are arranged to form an included angle A (shown in FIG. 4) of preferably approximately 20 degrees to 40 degrees, more preferably, approximately 25 degrees to 35 degrees, and most preferably, 33 degrees to 35 degrees (for example, about 34.4 degrees). The pair of nose pads 4 extend upwards with a decreasing interval until the gap becomes zero, that is, the pair of nose pads 4 intersect with each other to form an upper joint 43 or to be connected to an additional upper joint 43. Alternatively, when the interval is not zero (that is, the pair of nose pads 4 do not come into contact), the pair of nose pads 4 are connected to each other via the additional upper joint 43. According to a preferred concept of the present invention, the upper joint 43 particularly preferably has a magnetic attraction structure. That is, the body of the upper joint 43 is a magnet or the upper joint 43 is additionally provided with a magnet attraction head, so that the upper joint 43 can be connected to a corresponding magnetic attraction structure on the frame of the glass 1 via a magnetic attraction effect, so that the nose pad assembly has a magnetic attraction structure that can be easily disassembled, and it is convenient to disassemble, clean, change or repair the nose pad assembly.

In a preferred embodiment of the present invention, a foolproof design is provided on the upper joint 43. For example, without constituting a limitation, the upper joint 43 may be constructed into a shape that is at least partially asymmetrical, for example, a non-cylindrical shape, for example, a polyhedral shape, a semi-cylindrical shape, a parallelepipedic shape, a cubic shape, and is preferably, for example, a semi-cylinder whose cross section is a semicircle. A corresponding mounting hole with basically the same shape and size may be provided at a corresponding mounting position on the main body of the glass 1, and is used to insert and mount the upper joint 43. A correct mounting orientation of the upper joint 43 is determined according to the mounting hole having an asymmetrical shape, so as to provide a foolproof mounting feature.

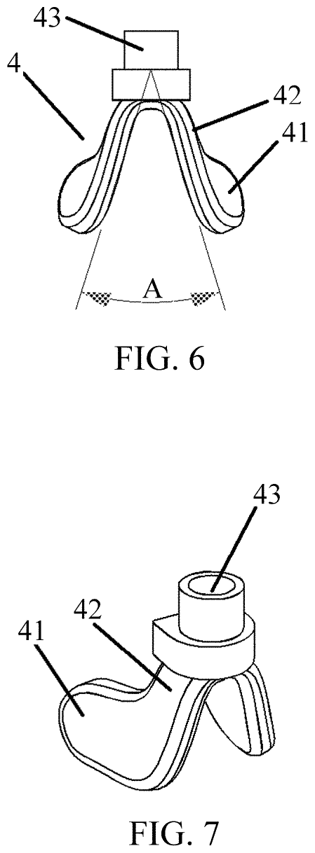

FIG. 6 is a three-dimensional view of a nose pad assembly according to a preferred embodiment of the present invention seen from an approximately front angle, and schematically shows the basic structure of the nose pad assembly. FIG. 7 is a three-dimensional view of the nose pad assembly shown in FIG. 6 from an approximately side rear angle, and schematically shows the basic structure of the nose pad assembly from the approximately side rear angle.

According to a particular preferred embodiment of the present invention, the nose pad 4 is made of a soft material, or a covering or coating made of a soft material is provided at a position that is on the nose pad 4 and is in contact with the nasal bridge. The covering or coating is, for example, but is not limited to, a resin or silica gel covering or coating, thereby further improving a fit with the nasal bridge, and reducing the pressure exerted on the nasal bridge, so that the glass 1 can be comfortably worn for a long time.

This pair of nose pads 4 preferably have a symmetrical structure and the same weight.

According to a particular preferred embodiment, as shown in FIG. 4 and FIG. 5, for the nose pad 4 of the present invention, a design of a bent-shaped or an approximately L-shaped raised nose pad is used. For example, to implement this design, according to a preferred embodiment, the nose pad 4 includes a nose pad support 42 and a nasal bridge contact portion 41 that together form an approximately bent shape or approximately L shape, as shown in FIG. 4 and FIG. 5. Particularly, a flaring design is preferably used for the nasal bridge contact portion 41. That is, the nasal bridge contact portion 41 is formed of a flaring part or is at least partially provided with a flaring part. In one aspect, the flaring part has a larger width than the nose pad support 42 (as shown in FIG. 5), so as to provide a larger contact area when the flaring part is in contact with the nasal bridge. In another aspect, the flaring part extends outwards from the nose pad support 42 (as clearly shown in FIG. 4), so that while being in contact with and fit the vertical part of the nasal bridge, the flaring part may further contact and better fit positions extending outwards from the nasal bridge to the alae of the nose. With the two aspects, the contact area with the nasal bridge is significantly increased, and an improved fit is provided, so that the nose pads bear weight more effectively, and there is less pressure on the nasal bridge. Therefore, the pressure on the nasal bridge is greatly reduced, the comfort during wear is greatly improved, and comfortable wear for a long time is allowed. In addition, such a design further enables the line of sight of a user to be level with a display screen, and a particular distance can be kept between the forehead of the user and the glass. Therefore, the weight of the glass is not exerted on the forehead, and such high nose pads can effectively insulate heat and facilitate dissipation of heat generated during normal operation and use of the glass 1.

Preferably, the nose pad support and the nasal bridge contact portion are integrally molded, preferably, are integrally molded in an injection molding manner. Certainly, a design other than integrated molding may be used for the nose pad support and the nasal bridge contact portion. For example, a design of sections connected to each other may be used.

According to this particular preferred embodiment of the present invention, as shown in FIG. 4 and FIG. 5, a structure with an increasing width and height is used at positions where the pair of nose pads 4 are in contact with the nasal bridge of a human, to facilitate the fixation on the nasal bridge with an increased contact area, thereby reducing pressure and facilitating long-time wear.

In addition, two battery modules 5 are preferably symmetrically disposed on the glass temples 2. Certainly, if necessary, the glass 1 may also be connected to an external large-capacity power supply through a power connection line (not shown in FIG. 1). According to a preferred embodiment of the present invention, a standard single battery module 5 can ensure continuous working of the augmented reality smart glass according to the present invention.

As shown in FIG. 2, the control button 8 may be respectively disposed on the two glass temples 2 to jointly control or separately control the content displayed by the imaging system 3. The position of the control button 8 shown in the figure is only exemplary. The control button 8 may be alternatively disposed on a side of the glass temple 2 or the glass frame 6. Preferably, a pair of control buttons 8 are disposed to balance the weight distribution.

In addition, a heat sink structure 7 is disposed on the glass frame 6 and is usually a hollowed-out structure or any other structure that facilitates dissipation of heat inside the glass frame 6.

To further reduce the overall weight of the augmented reality smart glass according to the present invention, the glass temples 2 and the glass frame 6 are usually made of a light material such as a composite material, a light alloy, and a carbon fiber composite material.

A multifunctional button 9 may be disposed on the glass temple 2. The button may be a user-defined button. A button function of the button can be defined on a user setting interface according to a use requirement of a wearer, thereby greatly expanding the application scope of the augmented reality smart glass according to the present invention.

Preferably, the nose pad 4 and the imaging system 3 shown in FIG. 3 are both designed to have detachable structures. In this way, during storage of the glass, tail-end parts of the glass temple 2, the battery module 5, the nose pad 4 and the imaging system 3 may be disassembled and separately stored, so that the volume and weight of the glass are further reduced during stored, and it is convenient to carry and transport the glass.

According to several functional requirements for implementing the glass 1, a built-in loudspeaker and an earphone jack may be respectively disposed at the positions of the reference numerals 12 and 13. The two positions are close to the ears of a wearer, so that the wearer can clearly hear sound from the built-in loudspeaker even in a noisy environment. If earphones are used, it is not necessary to arrange an excessively long earphone connection line, thereby avoiding discomfort during wear due to winding or dangling of an earphone line.

To further reduce the energy consumption of the glass 1, reduce the volume and weight of a circuit part of the augmented reality smart glass, and improve the comfort during wear, an HDI board design is used for a circuit board, so that the volume of a PCB board is minimized.

A person skilled in the art may understand that although FIG. 1 shows a binocular augmented reality smart glass, a person skilled in the art may further completely understand that the user-friendly fixation system in the present invention is obviously also applicable to a monocular augmented reality smart glass, and also applicable to a monocular or binocular virtual reality smart glass.

The augmented reality smart glass according to the present invention may be widely applied to different scenarios. For example, in a repair application, the augmented reality smart glass can present a repair manual to a repairman in a manner of text, picture, video, speech information or the like, and superimposes digital repair information on actual operation objects to instruct and guide the repairman to use different tools, operation gestures, and combinations of materials. In a practical operation training application, the augmented reality smart glass can enable a trainee to gain theoretical knowledge and experience practical operations. The augmented reality smart glass can further be applied to various scenarios such as management of front-line workers and remote assistance applications.

According to a specific embodiment of the present invention, a working process of the augmented reality smart glass of the present invention is briefly described below with reference to engine repair operations.

An engine repairman wears the augmented reality smart glass of the present invention, turns on power, connects to WiFi, and logs in to an ID. An engine repair work list and procedure are displayed on display glasses of the augmented reality smart glass. According to the progress of the repair procedure, operations and required materials required in a current procedure are listed. For example, a camera on the glass is used to recognize/determine the model of a spanner required to disassemble an engine, and required materials, special notes, and the like concerning a specific procedure are displayed on the display glasses. Therefore, by using the augmented reality smart glass of the present invention, the repairman can interact with a backend server in real time to receive smart guidance for the repair process, thereby avoiding errors. Moreover, the augmented reality smart glass may further collect and store work data on augmented reality smart glasses worn by a plurality of groups of repairmen, so as to provide work duration of the repairmen, error rates, data statistics about error-prone steps, and related data of individual repairmen, thereby providing personalized training for repairman and evaluate the work of each repairman in a full process. The augmented reality smart glass of the present invention is particularly applicable to various application scenarios such as training, complex repair, and maintenance.

Although only some features of the embodiments are shown and described herein, a person skilled in the art will conceive of many variations and changes. Therefore, it should be understood that the appended claims shall cover all such variations and changes that fall within the spirit of the present invention.

What is claimed is:

1. An integrated binocular augmented reality smart glass, comprising glass temples, an imaging system, a nose pad, a battery module and a glass frame, wherein a circuit board processor module and a control system are integrated therein; the glass temples form an approximately annular open structure surrounding a head outline, and the battery module is mounted at a middle position of the glass temples; and the imaging system comprises filter glasses, display glasses and functional glasses, wherein tail-end parts of the glass temples, the filter glasses and the functional glasses of the imaging system, and the nose pad are all detachable.

2. The augmented reality smart glass according to claim 1, comprising a pair of glass temples, a set of imaging systems, a pair of nose pads and a set of battery modules, wherein the battery module is preferably arranged under each glass temple, and the nose pad is preferably an L-shaped raised nose pad.

3. The augmented reality smart glass according to claim 1, wherein a control button is disposed on each glass temple, and a user-defined multifunctional button is preferably further disposed on each glass temple.

4. The augmented reality smart glass according to claim 1, wherein a heat sink structure is further disposed on the glass frame.

5. The augmented reality smart glass according to claim 1, wherein a built-in loudspeaker, an earphone jack and a USB interface supporting charging and data transmission are further disposed at a front-end part of the glass temple, and/or, an HDI board design is used for a circuit board of the smart glass.

6. A multi-layer augmented reality smart glass, comprising glass temples, an imaging system, a nose pad, a battery module and a glass frame, wherein the imaging system is a multi-layer structure, and comprises filter glasses, display glasses and functional glasses, and the filter glasses and the functional glasses are respectively located at two sides of the display glasses and are mounted on the glass frame.

7. The smart glass according to claim 6, wherein the filter glasses and the functional glasses are both mounted on the glass frame via detachable structures, and preferably, magnetic attraction structures.

8. The smart glass according to claim 6, wherein the functional glasses are vision correction glasses.

9. The smart glass according to claim 6, wherein the filter glasses serve as a background wall for image projection, and/or the filter glasses can filter out strong ambient light.

10. A user-friendly fixation system for a smart glass, in particular, an augmented reality smart glass, wherein the user-friendly fixation system comprises:
a detachable nose pad assembly, wherein the nose pad assembly at least comprises a pair of nose pads, and the nose pads increase a contact area between the smart glass and the nasal bridge of a user when the user wears the smart glass; and
a pair of foldable glass temples, wherein each glass temple at least comprises a front glass-temple section and a rear glass-temple section, and the foldable glass temples are formed to basically match the head shape of the user when the user wears the smart glass.

11. The user-friendly fixation system according to claim 10, wherein the pair of nose pads of the detachable nose pad assembly are arranged to form an included angle of approximately 20 degrees to 40 degrees, more preferably, approximately 25 degrees to 35 degrees, and most preferably, 33 degrees to 35 degrees, and extend upwards to intersect with each other to form an upper joint or to be connected to an additional upper joint.

12. The user-friendly fixation system according to claim 11, wherein the upper joint has a magnetic attraction structure, and/or the upper joint has a foolproof design.

13. The user-friendly fixation system according to claim 11, wherein the nose pad is a bent-shaped or an approximately L-shaped raised nose pad, each nose pad is formed of a nose pad support and a nasal bridge contact portion that are preferably integrally molded and form an approximately bent shape or an approximately L shape, and the nasal bridge contact portion has a flaring part.

14. The user-friendly fixation system according to claim 13, wherein the nasal bridge contact portion has a covering or coating made of a soft material.

15. The user-friendly fixation system according to claim 10, wherein the foldable glass temple has an increasing width, and preferably the front glass-temple section has a structure with an increasing width.

16. The user-friendly fixation system according to claim 10, wherein the rear glass-temple section is extended to form a curvature that basically matches the back of the head of the user.

17. The user-friendly fixation system according to claim 10, wherein the pair of foldable glass temples form a completely closed headband structure or an approximately annular open structure.

18. The user-friendly fixation system according to claim 10, wherein the foldable glass temples are constructed to enable a member that is mounted on the foldable glass temples and can additionally serve as a counterweight to be positioned near ear fulcrums or located at a position behind the ear fulcrums in a worn state.

19. The user-friendly fixation system according to claim 10, wherein a hole is opened in the foldable glass temple, preferably at an approximately middle position of the rear glass-temple section.

20. Use of the user-friendly fixation system according to claim 10 in an integrated binocular augmented reality smart glass or a multi-layer augmented reality smart glass.
